(19) United States
(12) Patent Application Publication
(10) Pub. No.: US 2019/0008286 A1
(43) Pub. Date: Jan. 10, 2019

(54) Mattress Structure and Production Method of the Same

(71) Applicant: Zhejiang Natural Travel Goods Co., Ltd., Taizhou City (CN)

(72) Inventors: Yonghui XIA, Taizhou City (CN); Jinglong CAO, Taizhou City (CN)

(73) Assignee: Zhejiang Natural Travel Goods Co., Ltd., Taizhou City (CN)

(21) Appl. No.: 15/687,887

(22) Filed: Aug. 28, 2017

(30) Foreign Application Priority Data
Jul. 7, 2017 (CN) 201710550616.X

(51) Int. Cl. A47C 27/14; A47C 27/08; B68G 5/02; B68G 7/05

(52) U.S. Cl. CPC A47C 27/144; A47C 27/088; A47C 27/081; B68G 7/05; B68G 5/02

(57) ABSTRACT

Provided are a mattress structure and a production method of the same, relating to the technical field of inflatable beds. The mattress structure includes: a top layer, a sponge layer and a bottom layer that are connected successively, wherein a plurality of first grooves are provided in the sponge layer. In the mattress structure, a plurality of first grooves are provided in the sponge layer arranged between the top layer and the bottom layer, which can lighten the weight of the sponge layer and accordingly, the weight of the whole mattress structure; moreover, not only the weight can be lightened, but also the used amount of sponge can be saved, which means that it has the advantages of convenient use and energy saving etc.

### PRIORITY

This application claims priority of Chinese application CN 201710550616.X filed on Jul. 7, 2017, the contents of all of which are incorporated herein by reference.

### TECHNICAL FIELD

The present invention relates to the technical field of inflatable beds, and particularly to a mattress structure and a production method of the same.

### BACKGROUND ART

There are many types of traditional beds, such as flat beds, four-poster beds, bunk beds and so on. A bed is not only a place for rest, but also a simple seat. Traditional mattresses have deficiencies and shortages of large size, heavy weight, inconvenience of transport, difficulty in cleaning and easy breeding of bacteria. Moreover, traditional mattresses have poor elasticity, and hence their effect of falling asleep comfortably is bad.

Utilizing the all-pervasive characteristic of air, an inflatable bed can be hundred percent fitted with a human body during the sleeping of human, so that each part of the human body is uniformly stressed, hereby overcoming the problem of disturbance of blood circulation caused by uneven stress distribution of traditional beds, and thus, inflatable beds are also known abroad as health beds. Inflatable beds get rid of the shortage of bulkiness of traditional furniture and can be freely placed indoors and outdoors.

Existing inflatable mattresses are filled internally with infillings, such as sponge, etc., to lighten the weight of the mattresses and for better inflating and resilience of the mattresses during use. However, existing inflatable mattresses have a relatively great weight, which renders that the whole inflatable bed is heavy and is difficult to transport and carry.

The present application is to better solve the problem of a relatively heavy mattress, wherein the sponge in the inflatable mattress is treated, so as to achieve the effect of a minimal weight of the mattress.

### DISCLOSURE OF THE INVENTION

An object of the present invention is to provide a mattress structure, so as to solve the technical problem that an existing processing mode has a poor effect and is time-wasting.

Another object of the present invention is to provide an inflatable bed including a mattress structure provided above.

In order to solve the above-mentioned technical problem, the following technical solution is employed in the present invention: a mattress structure provided in a first aspect of the present invention includes: a top layer, a sponge layer and a bottom layer that are connected successively, wherein a plurality of first grooves are provided in the sponge layer.

In any of the above technical solutions, further, the first grooves are arranged in a transverse direction of the sponge layer.

In any of the above technical solutions, further, each of the first grooves is in an inverted-trapezoidal shape, a dovetail-like shape or a rhombic shape.

In any of the above technical solutions, further, the first groove in a dovetail-like shape has a diameter gradually reducing in a direction from the bottom layer to the top layer.

In any of the above technical solutions, further, an adhesive layer is arranged respectively between the top layer and the sponge layer and between the bottom layer and the sponge layer. The material of the adhesive layer may be TPU, PVC or EVA, or various other polymer composite materials that can bond the sponge layer to the top layer and to the bottom layer with a hot-melting operation or a high frequency operation, that is to say, the material of the adhesive layer may also be TPE, TPR, TPV, TPO, TPVC, TPVE, glue or the like.

In any of the above technical solutions, further, the first grooves are processed by employing a numerically controlled cutting machine or sponge splicing.

The position of the sponge layer used in prior art, which is at a certain distance from the bottom and the top, is reversed for cutting, the existing sponge layer is cut into two pieces and two mattress structures are produced, thereby the weight can be lightened and the used amount of the sponge layer is also greatly saved.

In any of the above technical solutions, further, the top layer and the bottom layer are both TPU composite fabric layers.

In any of the above technical solutions, further, either the top layer or the bottom layer is provided with an air charging nozzle that is in communication with the sponge layer.

In any of the above technical solutions, further, the first groove is provided with heat insulation cotton and/or a light reflecting film.

An inflatable bed provided in a second aspect of the present invention is provided with the mattress structure provided in the first aspect, and thus has all the beneficial effects of the mattress structure provided in the first aspect, and no further detailed description will be made pointwise here.

The present invention further provides a method for producing a mattress structure as mentioned above, wherein the specific steps are as follows:

S1: cutting a sponge layer into two sponge layers each provided with first grooves; and

S2: arranging the sponge layers provided with the first grooves between a top layer and a bottom layer, and connecting each of the sponge layers respectively with the top layer and the bottom layer.

By employing the above mentioned technical solutions, the present invention has the following beneficial effects:

In the mattress structure provided in the present invention, a plurality of first grooves are provided in the sponge layer arranged between the top layer and the bottom layer, which can lighten the weight of the sponge layer and accordingly, the weight of the whole mattress structure; moreover, not only the weight can be lightened, but also the used amount of sponge can be saved, which means that it has the advantages of convenient use and energy saving etc.

Further, the first grooves are arranged in a transverse direction of the sponge layer, which lightens the weight of the sponge layer to the greatest extent.

Further, the first grooves are in an inverted-trapezoidal shape, a dovetail-like shape or a rhombic shape.

Further, the first groove in a dovetail-like shape has a diameter gradually reducing in a direction from the bottom layer to the top layer, which lightens the weight of the sponge layer to a relatively great extent.

Further, the arrangement of heat insulation cotton and/or a light reflecting film in the first groove can enhance the heat insulation of the mattress structure.

Additional aspects and advantages of the present invention will become evident in the following description or will be understood through the implementation of the present invention.

### BRIEF DESCRIPTION OF THE DRAWINGS

In order to more clearly describe specific embodiments of the present invention or technical solutions in the prior art, the drawings to be used in the description of the specific embodiments or the prior art will be simply presented below; and obviously, the drawings in the following description are certain embodiments of the present invention, and for a person skilled in the art, further drawings could be obtained according to these drawings without using inventive efforts.

FIG. 1 is a structural schematic diagram showing a side surface of a mattress structure provided in Example 1 of the present invention, with first grooves in an inverted-trapezoidal shape;

FIG. 2 is a perspective structural schematic diagram of a sponge layer in FIG. 1;

FIG. 3 is a structural schematic diagram showing a side surface of an inflatable bed provided in FIG. 1;

FIG. 4 is a structural schematic diagram showing a side surface of the sponge layer provided in Example 1 of the present invention, with first grooves in a rhombic shape;

FIG. 5 is a structural schematic diagram showing a side surface of the sponge layer provided in Example 1 of the present invention, with first grooves in a rectangular shape;

FIG. 6 is a perspective structural schematic diagram of the sponge layer provided in Example 1 of the present invention, with first grooves in a rectangular shape;

FIGS. 7-9 are structural schematic diagrams showing a sponge layer provided in Example 2 of the present invention, with first grooves in a dovetail-like shape of different forms;

FIG. 10 is a structural schematic diagram showing the sponge layer provided in Example 2 of the present invention, with first grooves in another dovetail-like shape;

FIG. 11 is a perspective structural schematic diagram of the sponge layer in FIG. 10;

FIG. 12 is a perspective structural schematic diagram of the sponge layer in FIG. 11, with second grooves provided thereon;

FIGS. 13-14 are structural schematic diagrams showing the sponge layer provided in Example 2 of the present invention, with first grooves in another dovetail-like shape;

FIG. 15 is a perspective structural schematic diagram of the sponge layer in FIG. 14;

FIG. 16 is a structural schematic diagram showing the sponge layer provided in Example 2 of the present invention, with first grooves in another dovetail-like shape; and

FIG. 17 is a schematic diagram showing the processing of the sponge layer using a numerically controlled cutting machine, provided in Example 3 of the present invention.

### REFERENCE SIGNS

1: top layer; 2: bottom layer; 3: sponge layer; 4: first groove; 5: heat insulation cotton; 6: second groove; and 7: cutting knife.

### DETAILED DESCRIPTION OF THE EMBODIMENTS

In the following contents, clear and complete description regarding the technical solutions of the present invention will be made with reference to the drawings, and obviously, the described examples are merely some but not all examples of the present invention. Based on the examples in the present invention, further examples that could be obtained by a person skilled in the art without inventive efforts all fall in the scope of protection of the present invention. It shall be clarified that without causing conflicts, the examples of the present application and features in the examples may be combined with each other.

In the description of the present invention, it shall be clarified that orientation or position relationships indicated by terms, such as “central”, “upper”, “lower”, “left”, “right”, “vertical”, “horizontal”, “inner”, and “outer”, are orientation or position relationships shown based on the drawings, only for facilitating the description of the present invention and for simplifying the description, rather than indicating or implying that the specified device or element must have a specific orientation, and be constructed and operated in a certain orientation, and therefore cannot be construed as limiting the present invention. In addition, terms such as “first”, “second”, and “third” are used merely for purpose of description, and cannot be construed as indicating or implying to have importance in relativity.

In the description of the present invention, it shall be clarified that, unless otherwise expressly specified and defined, terms such as “mount”, “connect”, and “connection” shall be construed in a broad sense. For example, it could be either a fixed connection, or a detachable connection, or an integrated connection; it could be either a mechanical connection, or an electrical connection; and it could be either a direct connection, or an indirect connection through an intermediate, or an inner communication between two elements. For a person skilled in the art, the specific meanings of the above-mentioned terms in the present invention could be construed in accordance with specific circumstances.

In the following contents, the present invention will be further explained and described combined with specific embodiments.

### Example 1

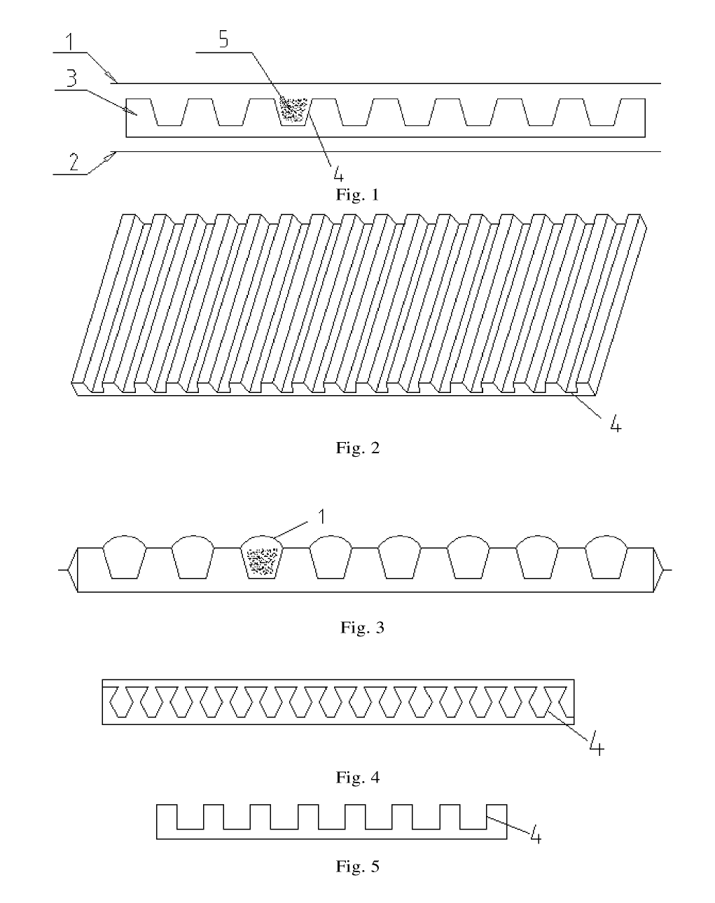

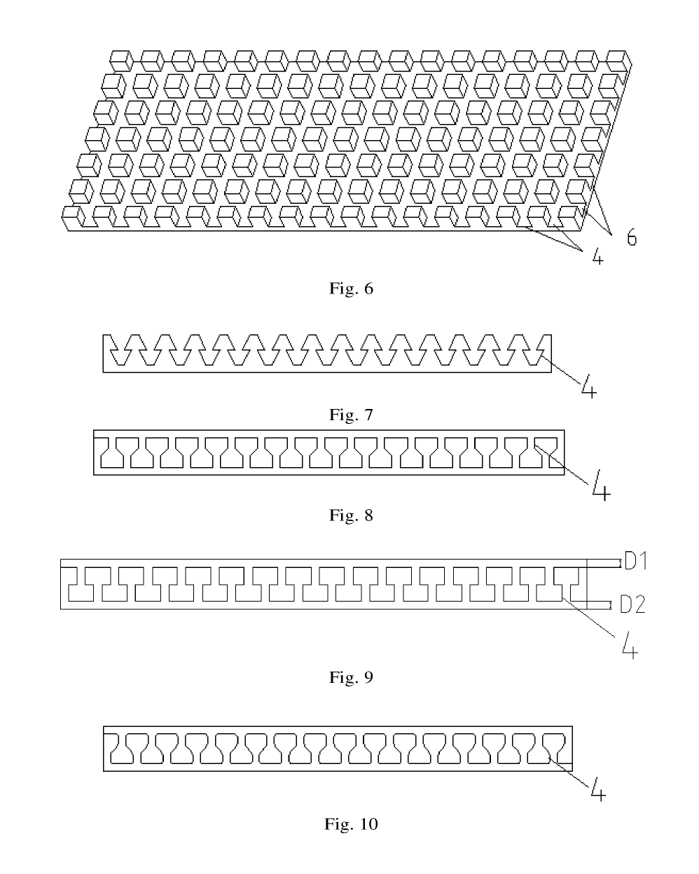

As shown in FIGS. 1-6, a mattress structure provided in an example of the first aspect of the present invention includes: a top layer 1, a sponge layer 3 and a bottom layer 2 that are connected successively, wherein a plurality of first grooves 4 are provided in the sponge layer 3.

That is to say, the sponge layer 3 is arranged between the top layer 1 and the bottom layer 2.

In any of the above technical solutions, further, the first grooves 4 are arranged in a transverse direction of the sponge layer 3, which lightens the weight of the sponge layer to the greatest extent. The plurality of first grooves 4 are uniformly distributed in a longitudinal direction of the sponge layer 3. In FIG. 2, the left-right direction is the longitudinal direction which is relatively longer, and the front-back direction is the transverse direction, and the arrangement of the first grooves in the transverse direction allows the uniform distribution of a great number of first grooves 4 in the longitudinal direction, which makes the weight of the sponge layer to be relatively light.

In any of the above technical solutions, further, the first grooves 4 are in an inverted-trapezoidal shape, a dovetail-like shape or a rhombic shape. It may also be a rectangular groove or a circular arc groove, and no limitation is made in the aspect of form, and first grooves of any form all fall in the scope of protection of the present invention, as long as an accommodating space can be formed therein.

In any of the above technical solutions, further, an adhesive layer is arranged respectively between the top layer 1 and the sponge layer 3 and between the bottom layer 2 and the sponge layer. The material of the adhesive layer may be TPU, PVC or EVA or various other polymer composite materials that can bond the sponge layer 3 to the top layer 1 and to the bottom layer 2 with a hot-melting operation or a high frequency operation, that is to say, the material of the adhesive layer may also be TPE, TPR, TPV, TPO, TPVC, TPVE, glue or the like.

In any of the above technical solutions, further, the first grooves 4 are processed by employing a numerically controlled cutting machine or sponge splicing. As to the mode of sponge splicing, sponge blocks are arranged on an underlying sponge layer, wherein the sponge blocks are thicker than the underlying sponge layer. Specifically, a plurality of sponge blocks can be adhered on the underlying sponge layer, and first grooves 4 are formed respectively between adjacent sponge blocks. For example, the thickness of the sponge block is 40 mm, and the underlying sponge layer has a thickness of 10 mm, and a mattress structure of 50 mm is formed by adhering the both together.

Specifically, the underlying sponge layer may also be provided with a plurality of through holes, wherein the through holes are matched with the sponge blocks, then a plurality of sponge blocks is placed in the through holes of the underlying sponge layer, and first grooves 4 are formed respectively between adjacent sponge blocks. For example, the thickness of the sponge block is 50 mm, and the underlying sponge layer has a thickness of 10 mm, and a mattress structure of 50 mm is eventually formed by adhering the sponge blocks to the top layer and the bottom layer.

The position of the sponge layer 3 used in prior art, which is at a certain distance from the bottom and the top, is reversed for cutting, the existing sponge layer 3 is cut into two pieces and two mattress structures are produced, thereby the weight can be lightened and the used amount of the sponge layer 3 is also greatly saved.

In any of the above technical solutions, further, the top layer 1 and the bottom layer 2 are both TPU composite fabric layers. The TPU composite fabric layer of the top layer 1 has elasticity, which facilitates the use, while the TPU composite fabric layer of the bottom layer 2 does not have elasticity.

In any of the above technical solutions, further, either the top layer 1 or the bottom layer 2 is provided with an air charging nozzle that is in communication with the sponge layer 3. The sponge layer 3 is in a compressed state normally, and when the use of the mattress is necessary, autoinflation can be realized just by opening the air charging nozzle in communication with the sponge layer 3. When the sponge layer 3 is restored, first grooves 4 cannot be in connection with the top layer 1, thus, the top layer 1 on the top of the first grooves 4 is automatically plumped up under the action of the air pressure, which achieves the effect of massage.

In any of the above technical solutions, further, the first groove 4 is provided with heat insulation cotton 5 and/or a light reflecting film, enhancing the heat insulation of the mattress structure.

An inflatable bed provided in the second aspect of the present invention is provided with the mattress structure provided in the first aspect, and thus has all the beneficial effects of the mattress structure provided in the first aspect, and no further detailed description will be made pointwise here.

The inflatable bed further includes an air bag, which is arranged corresponding to the sponge layer 3 between the top layer 1 and the bottom layer 2. That is to say, the air bag is arranged on the top of the sponge layer 3 and is used for the rest of head, and a seam is provided between the air bag and the sponge layer 3.

An air charging nozzle in communication with the air bag is provided on either the top layer 1 or the bottom layer 2, that is, the air charging nozzle is in communication with the air bag, and the air bag can be plumped up by blowing air through the air charging nozzle.

In order to facilitate storage, further, a strapping is provided on the top of the top layer 1 or the bottom layer 2. In a situation where an air bag is provided, the strapping can be arranged on the top of the air bag. When the inflatable mattress is not used, the mattress may be rolled up and strapped by the strapping for the purpose of storage.

In order to facilitate splicing, two sides of the top layer 1 and the bottom layer 2 can be pressed into edges by means of the seam, and the edges are located on two sides (left side and right side) of the mattress structure, and a connecting piece is arranged on the edges. The specific structure of the connecting piece is a snap fastener or a zipper.

The material of the air charging nozzle in Example 1 is engineering plastics, specifically engineering materials such as ABS, TPU, and PVC, and using this air charging nozzle can make the air charging nozzle closely attached to the top layer 1 or the bottom layer 2, which means that air leakage would not occur easily.

The present invention further provides a method for producing a mattress structure as mentioned above, wherein the specific steps are as follows:

S1: cutting a sponge layer into two sponge layers each provided with first grooves; and

S2: arranging the sponge layer provided with the first grooves between a top layer and a bottom layer, and connecting each of the sponge layers respectively with the top layer and the bottom layer.

In S1, the sponge layer is cut by employing a numerically controlled cutting machine, a whole cutting knife 7 is moved along the longitudinal direction of the sponge layer 3 to cut to obtain the first grooves, and after the cutting of the first grooves, a sponge layer of the same thickness is cut, and then the sponge layer is taken off for separate use.

In S2, the sponge layer provided with the first grooves is respectively connected to the top layer and the bottom layer via an adhesive layer.

### Example 2

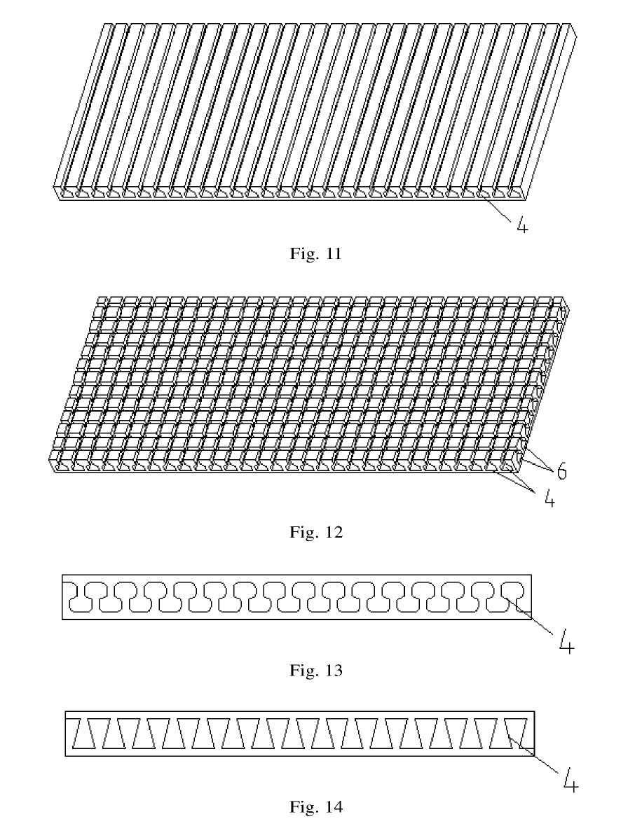

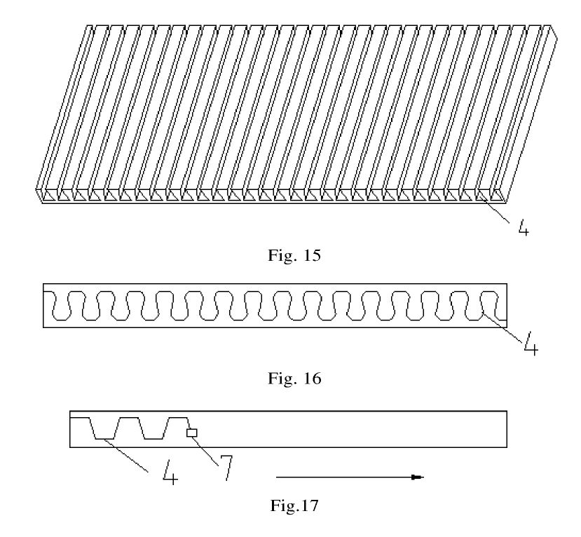

As shown in FIGS. 7-16, the first grooves 4 in the mattress structure provided in the present invention are present in an inverted-trapezoidal shape or a rhombic shape.

In any of the above technical solutions, further, the first groove 4 in a dovetail-like shape has a diameter gradually reducing in a direction from the bottom layer 2 to the top layer 1.

The dovetail-like shape may be a water-drop shape with a bigger bottom and a smaller top, and may also be various shapes such as an inverted cone with a bigger bottom and a smaller top, such structure can lighten the weight of the sponge layer 3 to a relatively great extent.

For example, a sponge layer of a thickness of 50 mm which is produced by employing the existing technique needs to be cut from a sponge layer of a thickness of 100 mm, while in a situation where a sponge layer of a thickness of 50 mm is to be produced with the present invention, a sponge layer of an overall thickness of 60 mm is used, wherein cutting is performed after the reservation of thicknesses D1 and D2 from the top and the bottom, wherein the thicknesses D1 and D2 are identical. In the present example D1 is 10 mm, the depth of the first grooves 4 is 40 mm. Two sponge layers having a thickness of 50 mm are formed from a sponge layer having a thickness of 60 mm by reserving a thickness and performing cutting, wherein the used amount of the sponge is saved compared with the prior art and the weight of the sponge layer is lighter.

In Example 2, the plurality of first grooves 4 can be uniformly distributed along the longitudinal direction of the sponge layer, or second grooves 6 may also be arranged in the longitudinal direction of the sponge layer, wherein a plurality of second grooves 6 are uniformly distributed along the transverse direction of the sponge layer. The arrangement of the second grooves 6 lightens the weight of the mattress structure to the greatest extent.

As to the mattress structure in Example 2, the sponge layer 3 may be perforated as required, and preferably, perforation can be performed along the transverse direction of the sponge layer 3, so as to better lighten the weight of the sponge layer 3, wherein processes such as numerically controlled cutting, heating wire, stamping, laser cutting, water jet scalpel, and splicing can be employed to realize the perforation along the transverse direction of the sponge layer 3. In order to increase the use strength, the above-mentioned sponge blocks can be perforated.

As the transverse length of the sponge layer 3 is relatively long, the distribution of the transverse perforations may be relatively intensive, such that the hollowing processing of the sponge layer 3 can be performed to a greatest extent, and the weight of the inflatable mattress can be lightened.

### Example 3

As shown in FIG. 17, the sponge layer 3 is processed in the present invention by employing a numerically controlled cutting machine, and the specific steps are as follows: the numerically controlled cutting machine includes a support and a cutting knife 7, with the sponge layer 3 being arranged on the support and the cutting knife 7 performing cutting according to a programmed shape, wherein the whole cutting knife 7 is moved along the longitudinal direction of the sponge layer 3 to perform the cutting, and the cut sponge layer 3 is used separately after the cutting.

In summary, as to the mattress structure provided in the present invention, a plurality of first grooves 4 are provided in the sponge layer 3 arranged between the top layer 1 and the bottom layer 2, which can lighten the weight of the sponge layer 3 and accordingly, the weight of the whole mattress structure; moreover, not only the weight can be lightened, but also the used amount of the sponge can be saved, which means that it has the advantages of convenient use and energy saving etc.

In the mattress structure provided in the present invention, numerical-controlled cutting is performed on an existing sponge layer, wherein the sponge layer is cut into two pieces, and the separated sponge layers have first grooves and may also be perforated as required along the transverse direction of the sponge layer. After the arrangement of materials such as heat insulation cotton in the first grooves, the sponge layer is arranged between the top layer and the bottom layer, and the three layers are connected together by employing processes such as hot-melting or high-frequency welding.

At last, it shall be clarified that the above-mentioned respective examples are only used for describing the technical solutions of the present invention, rather than limiting the same; although the present invention is described in detail with reference to the preceding respective examples, it shall be understood for a person skilled in the art that the technical solutions recorded in the preceding respective examples could still be modified, or partial or all technical features thereof could be substituted in an equivalent way; and the modifications or substitutions do not make the essence of the corresponding technical solutions depart from the scope of the technical solutions of the respective examples of the present invention. In addition, a person skilled in the art could understand: although some examples described here comprise certain features included in other examples, rather than other features, the combination of features from different examples indicates that it falls in the scope of the present invention and forms a different example. For example, in the claims, any of the claimed examples can be used in any combination with each other.

1. A mattress structure, comprising: a top layer, a sponge layer and a bottom layer that are connected successively, wherein a plurality of first grooves are provided in the sponge layer.

2. The mattress structure according to claim 1, wherein the first grooves are arranged in a transverse direction of the sponge layer.

3. The mattress structure according to claim 1, wherein the first grooves are in an inverted-trapezoidal shape, a dovetail-like shape or a rhombic shape.

4. The mattress structure according to claim 3, wherein each of the first grooves in a dovetail-like shape has a diameter gradually reducing in a direction from the bottom layer to the top layer.

5. The mattress structure according to claim 1, wherein an adhesive layer is arranged between the top layer and the sponge layer, and between the bottom layer and the sponge layer respectively.

6. The mattress structure according to claim 1, wherein the top layer and the bottom layer are both TPU composite fabric layers.

7. The mattress structure according to claim 1, wherein either the top layer or the bottom layer is provided with an air charging nozzle that is in communication with the sponge layer.

8. The mattress structure according to claim 1, wherein the first groove is further provided with heat insulation cotton and/or a light reflecting film.

9. An inflatable bed, comprising the mattress structure according to claim 1.

10. A method for producing the mattress structure according to claim 1, comprising steps as follows:
S1: cutting a sponge layer into two sponge layers, each of which is provided with first grooves; and
S2: arranging the sponge layers provided with the first grooves between a top layer and a bottom layer, and connecting each of the sponge layers respectively with the top layer and the bottom layer.

11. The method for producing the mattress structure according to claim 10, wherein the first grooves are arranged in a transverse direction of the sponge layer.

12. The method for producing the mattress structure according to claim 10, wherein the first grooves are in an inverted-trapezoidal shape, a dovetail-like shape or a rhombic shape.

13. The method for producing the mattress structure according to claim 12, wherein each of the first grooves in a dovetail-like shape has a diameter gradually reducing in a direction from the bottom layer to the top layer.

14. The method for producing the mattress structure according to claim 10, wherein an adhesive layer is arranged between the top layer and the sponge layer and between the bottom layer and the sponge layer respectively.

15. The method for producing the mattress structure according to claim 10, wherein the top layer and the bottom layer are both TPU composite fabric layers.

16. The method for producing the mattress structure according to claim 10, wherein either the top layer or the bottom layer is provided with an air charging nozzle that is in communication with the sponge layer.

17. The method for producing the mattress structure according to claim 10, wherein the first groove is further provided with heat insulation cotton and/or a light reflecting film.
